(19) United States
(12) Patent Application Publication
(10) Pub. No.: US 2026/0075350 A1
(43) Pub. Date: Mar. 12, 2026

(54) BLUETOOTH LOW-LATENCY GAMING HEADPHONES

(71) Applicant: OXTI Pte Ltd, Singapore (SG)

(72) Inventor: Chih-Feng Ho, Singapore (SG)

(21) Appl. No.: 18/830,604

(22) Filed: Sep. 11, 2024

(51) Int. Cl. H04R 1/10

(52) U.S. Cl. CPC H04R 1/1066; H04R 1/1008; H04R 1/105; H04R 1/1083; H04R 2420/07

(57) ABSTRACT

Bluetooth low-latency gaming headphones are provided, including a headband having connecting posts on two sides of a lower part of the headband. Lower parts of the connecting posts are connected to hinged posts, one end of which is connected to a protective shell. Inside the protective shell, there is a sound output tube. On the side wall of the protective shell adjacent to one side of the sound output tube, a fixed mesh is installed. On the outside of the fixed mesh, an ear loop fixture is set up. The protective shell near the ear loop fixture is evenly equipped with multiple Bluetooth receiving modules, all of which are connected to the sound output tube. A Bluetooth signal is receivable by any of the Bluetooth receiving modules, then transmitted inside the protective shell, and finally sent to the sound output tube.

### BACKGROUND OF THE INVENTION

### TECHNICAL FIELD OF THE INVENTION

The present invention relates to technical field of gaming headphones, and more particularly to Bluetooth low-latency gaming headphones.

### DESCRIPTION OF THE PRIOR ART

With the development of technology and the gradual increase in people’s living standards, in order to meet the demand for more comfortable headphones, a type of over-ear Bluetooth headphone is available in the market. This known structure includes a headband and headphones suspended from both ends of the bottom of the headband. Since this type of headphone relies mainly on the elastic clamping force of the headband for fixation, wearing it for an extended period can cause severe pressure and discomfort on the ears, resulting in poor market acceptance.

Nowadays, Bluetooth has eliminated the need for connecting cables, making headphones more convenient to use without the issues of tangling or knotting. However, Bluetooth is susceptible to external interference during use, which can lead to low-latency transmission issues. This is particularly problematic for gaming headphones, where latency can significantly affect the gaming experience.

### SUMMARY OF THE INVENTION

An objective of the present invention is to provide Bluetooth low-latency gaming headphones. By setting up multiple Bluetooth receiving modules, the transmission efficiency can be improved. During use, Bluetooth signals are received by any of the Bluetooth receiving modules, which then transmits the signal to the protective shell and finally to the sound output tube. This design helps avoid low-latency transmission issues and addresses the problem of Bluetooth being easily affected by external interference, which can cause low-latency transmission, especially in gaming headphones where latency significantly impacts the gaming experience.

According to an embodiment of the present invention, the Bluetooth low-latency gaming headphones include: a headband with connecting posts on both sides of the lower part; hinged posts connected to the lower part of the connecting posts; a protective shell connected to one end of the hinged posts; an internal sound output tube within the protective shell; a fixed mesh on the side wall of the protective shell adjacent to the sound output tube; an ear loop fixture on the outside of the fixed mesh; and multiple Bluetooth receiving modules evenly distributed around the protective shell near the ear loop fixture, all connected to the sound output tube.

Furthermore, one end of each of the multiple Bluetooth receiving modules is connected to an A/D converter. The A/D converter converts an analog signal into a transmission signal, which is then sent to the sound output tube for playback.

Furthermore, a connecting pin runs through both the hinged posts and the connecting posts. A torsion spring is installed on the outer wall of the middle part of the connecting pin. Both ends of the torsion spring extend and are fixed inside the hinged posts and connecting posts, respectively.

Furthermore, on the side of the hinged posts and connecting posts facing each other, connecting grooves are set up. Both sides of the torsion spring extend to the bottom of the connecting groove, and the ends of the torsion spring penetrate the bottom wall of the connecting groove and extend inside the hinged posts and connecting posts.

Furthermore, on the side wall of the protective shell outside the fixed mesh, an ear slot is set up. The bottom wall of the ear slot abuts the ear, and the ear loop fixture is installed on the side wall of the ear slot.

Furthermore, the ear loop fixture includes a shell, one end of which is fixed on the outer wall of the protective shell. An ear loop slot is set up on the upper part of the shell.

Furthermore, the ear loop slot is adapted to fit the ear loop. A buffer pad is installed on the inner wall of the ear loop slot.

Furthermore, the Bluetooth receiving modules are embedded in the outer wall of the protective shell. The protective shell has multiple embedding ports, and the embedding ports fit tightly with the Bluetooth receiving modules.

Furthermore, noise reduction cotton is installed between the sound output tube and the fixed mesh. The noise reduction cotton is compressed and fixed on the edge of the sound output tube.

Compared to existing technology, the beneficial effects of the present invention are as follows:

(1) By setting up multiple Bluetooth receiving modules, transmission efficiency is improved. During use, the Bluetooth signal is received by any of the Bluetooth receiving modules, which then transmits the signal to the protective shell and finally to the sound output tube. This prevents low-latency transmission issues. Additionally, the fixed mesh protects the interior of the protective shell, preventing external dust from entering and ensuring that the sound amplitude is not weakened when the sound is output.

(2) The ear loop fixture enhances the stability of the headphones. When the ear loop is fixed in the ear loop slot, the sound output tube is aligned with the ear canal, facilitating better reception of the audio. Additionally, the noise reduction cotton on the headphones reduces external interference, enhancing the user experience.

### BRIEF DESCRIPTION OF THE DRAWINGS

The drawings are intended to provide a further understanding of the present invention and form a part of the specification. They are used to explain the present invention along with the embodiments and do not constitute a limitation of the present invention. In the drawings:

FIG. 1 is a structural schematic diagram of the Bluetooth low-latency gaming headphones according to the present invention;

FIG. 2 is a schematic diagram of an internal structure of a protective shell of the Bluetooth low-latency gaming headphones according to the present invention;

FIG. 3 is a signal transmission principal diagram of the Bluetooth low-latency gaming headphones according to the present invention;

FIG. 4 is a schematic diagram of a connection between a connecting post and a hinged post of the Bluetooth low-latency gaming headphones according to the present invention; and

FIG. 5 is a structural schematic diagram of an ear loop fixture of the Bluetooth low-latency gaming headphones according to the present invention.

### DETAILED DESCRIPTION OF THE PREFERRED EMBODIMENTS

To make the objectives, technical solutions, and advantages of the present invention clearer, the following detailed description of the present invention is provided in conjunction with the drawings and embodiments. The specific embodiments described here are for the purpose of explaining the present invention and do not limit the scope of the present invention.

The following is a detailed description of the implementation of the present invention based on specific embodiments.

In the drawings of this embodiment, the same or similar reference numbers correspond to the same or similar components. In the description of the present invention, it should be understood that terms such as “up,” “down,” “left,” “right,” and other positional or directional terms are based on the orientations or positional relationships shown in the drawings. These terms are used for convenience in describing the present invention and simplifying the description and are not meant to indicate or imply that the described device or component must have a specific orientation or be constructed and operated in a specific orientation. Therefore, the positional relationships described in the drawings are for illustrative purposes only and should not be interpreted as limitations of the present invention. Those skilled in the art may understand the specific meanings of these terms based on the context.

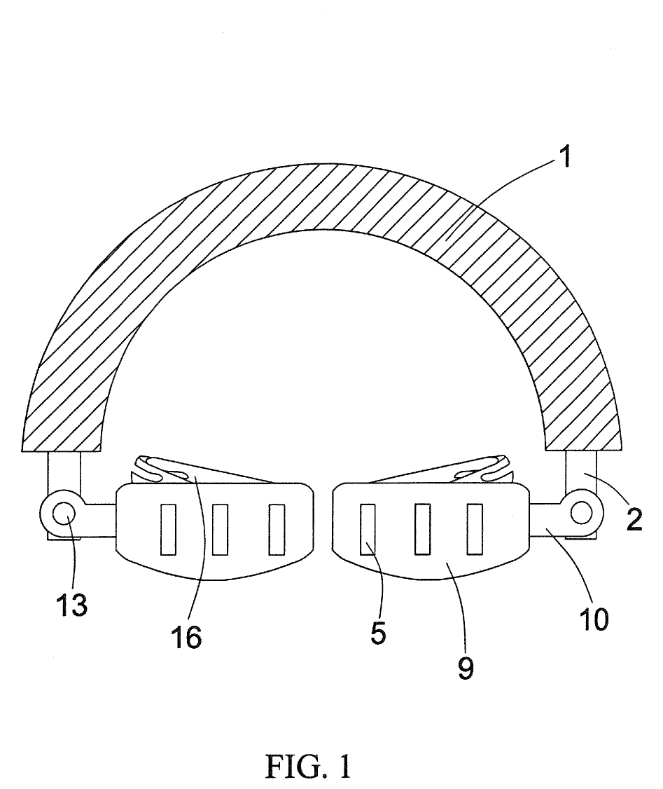

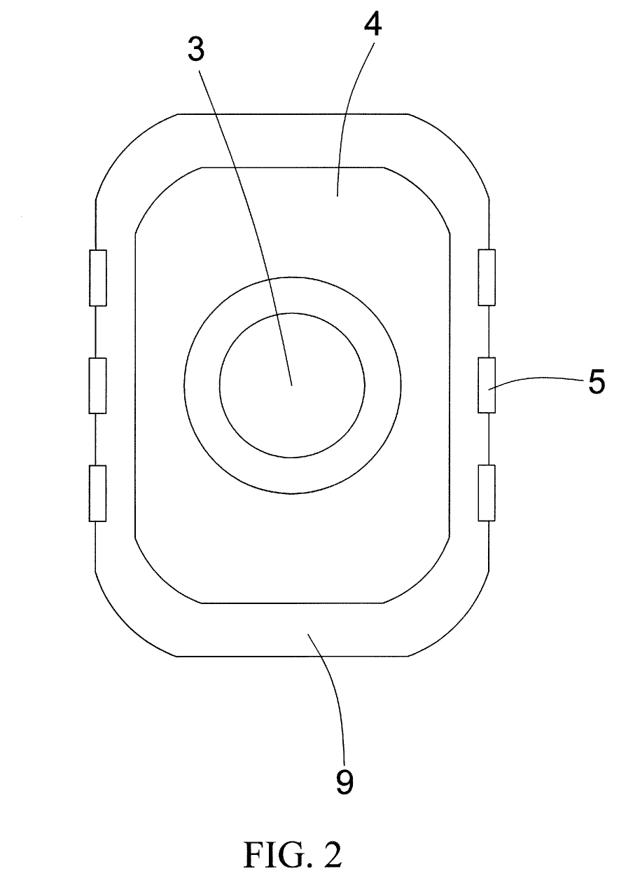

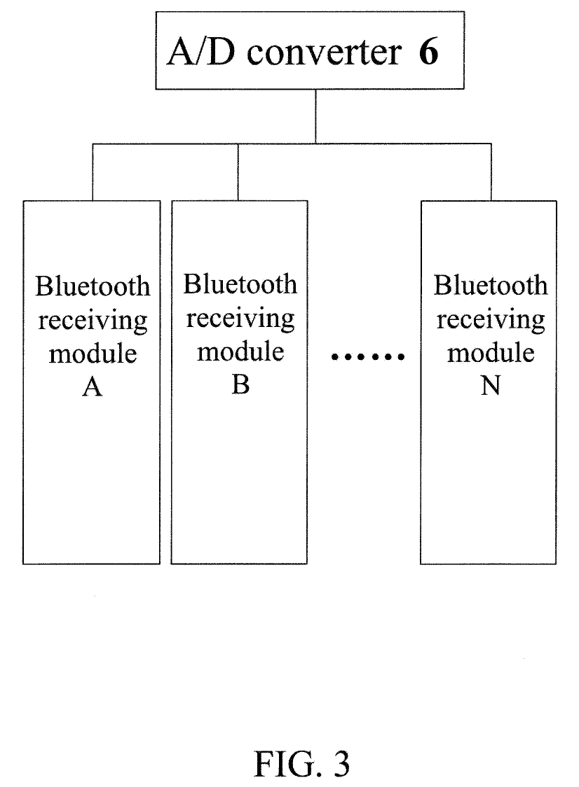

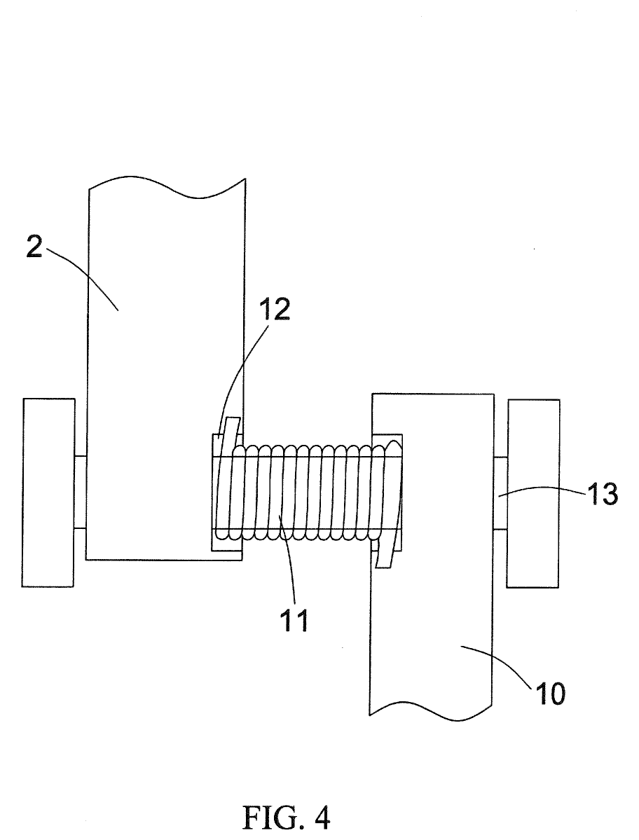

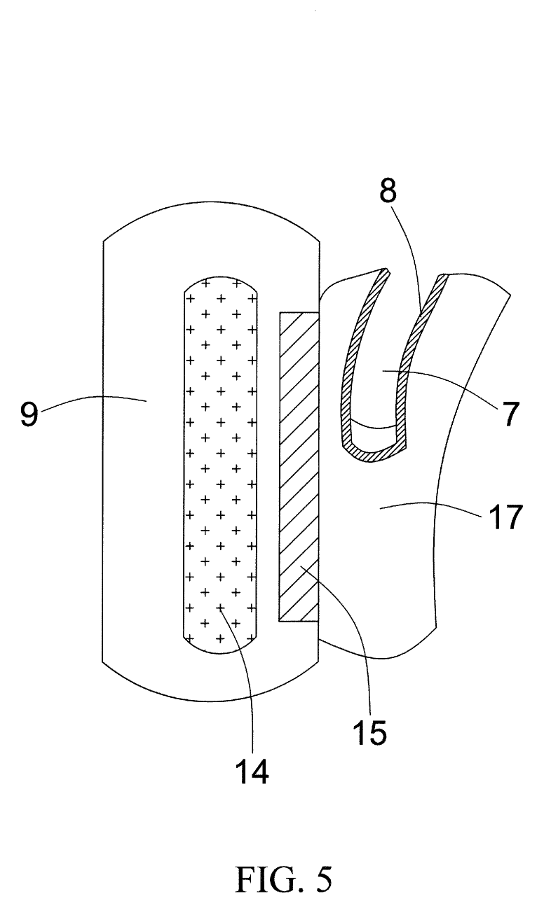

Referring to FIGS. 1-5, a preferred embodiment of the present invention is provided.

The Bluetooth low-latency gaming headphones comprise a headband (1) having connecting posts (2) on two sides of a lower part of the headband (1). Lower parts of the connecting posts (2) are connected to hinged posts (10) respectively, and one end of each of the hinged posts (10) is connected to a protective shell (9). Arranged inside the protective shell (9) is a sound output tube (14). Arranged on a side wall of the protective shell (9) adjacent to the sound output tube (14) is a fixed mesh (3), and outside the fixed mesh (3) is an ear loop fixture (16). Multiple Bluetooth receiving modules (5) are evenly distributed on two sides of the protective shell (9) near the ear loop fixture (16), all connected to the sound output tube (14). When in use, Bluetooth signals are received by any one of the Bluetooth receiving modules (5), which then transmits the signal to the protective shell (9) for processing and finally to the sound output tube (14) for emission. This setup avoids low latency in transmission, and the fixed mesh (3) protects the inside of the protective shell (9), preventing external dust from entering and ensuring timely sound output without compromising sound amplitude.

In the instant embodiment, each of the Bluetooth receiving modules (5) is connected to an A/D converter (6), which converts analog signals into digital signals for playback in the sound output tube (14). The A/D converter (6) facilitates the conversion between data signals, aiding in the transition between digital and analog signals.

In the instant embodiment, the hinged post (10) and the connecting post (2) are connected by a connecting pin (13). A torsion spring (11) is arranged around a middle of the connecting pin (13), with both ends of the torsion spring (11) extending into and fixed inside the hinged post (10) and connecting post (2). Connecting grooves (12) are provided on sides of the hinged post (10) and connecting post (2) that face each other. The torsion spring (11) extends into bottoms of the connecting grooves (12), and ends of the torsion spring (11) extend through the bottom walls of the connecting grooves (12) and extend into the interiors of the hinged post (10) and connecting post (2). This arrangement allows the protective shell (9) to fold inward toward the headband (1) when not in use, reducing the storage space required for the headphones.

In the instant embodiment, an ear slot (4) is provided on a side wall of the protective shell (9) outside the fixed mesh (3). A bottom wall of the ear slot (4) is contactable with an ear, and the ear loop fixture (16) is positioned on a side wall of the ear slot (4). The ear loop fixture (16) comprises a shell (17) fixed to an outer wall of the protective shell (9), with an ear loop slot (7) in an upper part of the shell (17). The ear loop slot (7) is adapted to the ear loop, and a buffer pad (8) is placed around an inner wall of the ear loop slot (7) to enhance the comfort of the ear loop.

In the instant embodiment, the Bluetooth receiving modules (5) are embedded in the outer wall of the protective shell (9), with multiple insertion ports on the protective shell (9) for the modules. The insertion ports are in interference fit with the Bluetooth receiving modules (5), securing them in place, with one end of the modules exposed to facilitate Bluetooth signal reception.

In the instant embodiment, noise reduction cotton (15) is placed between the sound output tube (14) and the fixed mesh (3). The noise reduction cotton (15) is compressed and secured around an edge of the sound output tube (14), reducing the impact of external noise on the sound quality.

In use, the user extends the protective shell (9) and places it on their head, ensuring that the ear loop slot (7) contacts the ear loop. The ear loop fixture (16) enhances the fixation of the headphones. When the ear loop is fixed in the ear loop slot (7), the sound output tube (14) aligns with the ear canal, facilitating optimal sound reception. The noise reduction cotton (15) minimizes the influence of external noise, improving user’s experience. During Bluetooth signal transmission, any Bluetooth receiving module (5) on the protective shell (9) can receive the signal, which is then processed within the protective shell (9) and delivered to the sound output tube (14). This setup prevents low-latency transmission issues and ensures that external dust does not enter the protective shell (9), maintaining sound amplitude.

The entire operational process can be controlled by a computer, along with PLC and other automation technologies, to achieve automated operation control. Sensors can be used in various stages for signal feedback, ensuring the sequential execution of steps. These aspects are common knowledge in automation control and will not be elaborated further in the instant embodiment.

Any aspects not detailed in the present invention are considered common knowledge to those skilled in the art.

Although specific embodiments of the present invention have been shown and described, it is understood that various modifications, alterations, substitutions, and variations may be made without departing from the principles and spirit of the present invention. The scope of the present invention is defined by the appended claims and their equivalents.

I claim:

1. Bluetooth low-latency gaming headphones, comprising a headband having connecting posts on two sides of a lower part of the headband, lower parts of the connecting posts being respectively connected to hinged posts, one end of which is connected to a protective shell, a sound output tube arranged inside the protective shell, a fixed mesh arranged on a side wall of the protective shell adjacent to one side of the sound output tube, an ear loop fixture arranged on an outside of the fixed mesh, and multiple Bluetooth receiving modules evenly arranged on the protective shell near the ear loop fixture and all connected to the sound output tube.

2. The Bluetooth low-latency gaming headphones according to claim 1, wherein one end of each of the multiple Bluetooth receiving modules is connected to an A/D converter, which converts the analog signal into a transmission signal to be transmitted to the sound output tube for playback.

3. The Bluetooth low-latency gaming headphones according to claim 2, wherein a connecting pin extends through both the hinged posts and the connecting posts, and a torsion spring is arranged on an outer wall of a middle part of the connecting pin, two ends of the torsion spring extending into and fixed inside the hinged posts and connecting posts, respectively.

4. The Bluetooth low-latency gaming headphones according to claim 3, wherein connecting grooves are respectively formed in a side of the hinged post and a side of connecting post facing each other, and the two ends of the torsion spring extend to bottoms of the connecting grooves respectively and penetrate through bottom walls of the connecting grooves and extend into the hinged post and connecting post.

5. The Bluetooth low-latency gaming headphones according to claim 4, wherein an ear slot is formed in a side wall of the protective shell outside the fixed mesh, a bottom wall of the ear slot being adapted to contact an ear, and the ear loop fixture is installed on a side wall of the ear slot.

6. The Bluetooth low-latency gaming headphones according to claim 5, wherein the ear loop fixture comprises a shell, one end of which is fixed on the outer wall of the protective shell, an ear loop slot being formed an upper part of the shell.

7. The Bluetooth low-latency gaming headphones according to claim 6, wherein the ear loop slot is fit to the ear loop, and a buffer pad is arranged on an inner wall of the ear loop slot.

8. The Bluetooth low-latency gaming headphones according to claim 7, wherein the Bluetooth receiving modules are embedded in the outer wall of the protective shell, and multiple embedding ports are set up on the protective shell, and the embedding ports fit tightly with the Bluetooth receiving modules.

9. The Bluetooth low-latency gaming headphones according to claim 8, wherein noise reduction cotton is arranged between the sound output tube and the fixed mesh, and the noise reduction cotton is compressed and fixed on an edge of the sound output tube.
